(19) United States
(12) Patent Application Publication
(10) Pub. No.: US 2015/0037306 A1
(43) Pub. Date: Feb. 5, 2015

(54) Adjuvant containing polyorganosiloxane and organic solvent for preparing a larvicidal tank mix

(71) Applicants: Claude Taranta, Stutensee (DE); Helmut Mueller, Weisenheim (DE); Susanne Stutz, Weinheim (DE); Egon Weinmueller, Limburgerhof (DE); James W. Austin, Wake Forest, NC (US)

(72) Inventors: Claude Taranta, Stutensee (DE); Helmut Mueller, Weisenheim (DE); Susanne Stutz, Weinheim (DE); Egon Weinmueller, Limburgerhof (DE); James W. Austin, Wake Forest, NC (US)

(73) Assignee: BASF SE, Ludwigshafen (DE)

(21) Appl. No.: 14/374,674

(22) PCT Filed: Jan. 21, 2013
(86) PCT No.: PCT/EP2013/051033

§ 371 Date: Jul. 25, 2014

Related U.S. Application Data
(60) Provisional application No. 61/592,009, filed on Jan. 30, 2012.

(51) Int. Cl. A01N 25/00; A01N 43/22; A01N 25/02; A01N 49/00; A01N 63/00; A01N 55/00; A01N 57/14; A01N 51/00

(52) U.S. Cl. CPC A01N 25/00; A01N 57/14; A01N 43/22; A01N 51/00; A01N 49/00; A01N 63/00; A01N 55/00; A01N 25/02
USPC 424/93.461; 514/107; 514/28; 514/471; 514/549; 424/93.46; 514/772.3

(57) ABSTRACT

The present invention relates to a method for controlling insects comprising the steps of preparing a tankmix by mixing a larvicide and a liquid adjuvant, wherein the adjuvant is essentially free of the larvicide and contains at least 1 wt % polyorganosiloxane, and at least 20 wt % synthetic organic solvent; and applying the tankmix on a water surface. The invention further relates to a liquid adjuvant for preparing a larvicidal tankmix, wherein the adjuvant is essentially free of a larvicide and contains at least 1 wt % polyorganosiloxane, and at least 20 wt % synthetic organic solvent. Finally, it relates to a method for preparing said adjuvant, comprising mixing the polyorganosiloxan and the synthetic organic solvent.

The present invention relates to a method for controlling insects comprising the steps of preparing a tankmix by mixing a larvicide and a liquid adjuvant, wherein the adjuvant is essentially free of the larvicide and contains at least 1 wt % polyorganosiloxane, and at least 20 wt % synthetic organic solvent; and applying the tankmix on a water surface. The invention further relates to a liquid adjuvant for preparing a larvicidal tankmix, wherein the adjuvant is essentially free of a larvicide and contains at least 1 wt % polyorganosiloxane, and at least 20 wt % synthetic organic solvent. Finally, it relates to a method for preparing said adjuvant, comprising mixing the polyorganosiloxan and the synthetic organic solvent. Combinations of preferred embodiments with other preferred embodiments are within the scope of the present invention.

The control of aquatic insects by silicon polymers is an important tool in public health management.

WO 2008/014566 discloses a composition for the protection of a body of water comprising 5 to 95 wt % silicone polymer, zero to 90 wt % carrier material and greater than zero to 20 wt % surfactant. This composition protects the liquid/gas interface from insect infestations and disrupts the mosquito lifecycle.

Object of the present invention was to overcome the disadvantages of the state of the art.

The object was solved by a method for controlling insects comprising the steps of preparing a tankmix by mixing a larvicide and a liquid adjuvant, wherein the adjuvant is essentially free of the larvicide and contains at least 1 wt % polyorganosiloxane, and at least 20 wt % synthetic organic solvent; and applying the tankmix on a water surface. In another embodiment, the method for controlling insects comprises the steps of preparing a tankmix by mixing a larvicide and a liquid adjuvant, wherein the adjuvant consists of at least 1 wt % polyorganosiloxane, at least 20 wt % synthetic organic solvent, and optionally formulation additives; and applying the tankmix on a water surface.

The object was also solved by a liquid adjuvant for preparing a larvicidal tankmix, wherein the adjuvant is essentially free of a larvicide and contains at least 1 wt % polyorganosiloxane, and at least 20 wt % synthetic organic solvent. In another embodiment, the liquid adjuvant for preparing a larvicidal tankmix consists of at least 1 wt % polyorganosiloxane, at least 20 wt % synthetic organic solvent, and optionally formulation additives.

Polyorganosiloxanes are polymers, in which silicon atoms are linked via oxygen atoms, each silicon atom bearing one or several organic groups. They are also known as silicones and reviewed by Moretto et al., Ullmann's Encyclopedia of Industrial Chemistry, 2000, Keyword “Silicones”.

The organo groups of the polyorganosiloxane comprise alkyl, aryl and/or polymeric groups. The polyorganosiloxane may be linear, cyclic (like trisiloxanes), branched or crosslinked. In a first preferred embodiment, the organo groups of the polyorganosiloxane comprise (preferably consist of) alkyl, and/or aryl groups. In a second preferred embodiment, the organo groups of the polyorganosiloxane comprise polymeric groups in addition to alkyl and/or aryl groups.

Examples of alkyl groups are C₁-C₁₂ alkyl, preferably methyl. Examples of aryl groups are phenyl or substituted phenyl groups, preferably phenyl. In particular, the polyorganosiloxane comprises polydimethylsiloxane (also known as dimethicone). The chemical composition of polydimethylsiloxane is generally represented by the formula (CH₃)₃SiO[SiO(CH₃)₂]ₙSi(CH₃)₃. The n has usually a value of at least 3, preferably at least 5. The value of n may be up to 5000, preferably up to 2000. Polydimethylsiloxanes are commercially available, e.g. from Dow Corning as Xiameter® PMX-200.

Preferred polymeric groups are polyether. Such compounds are also known as polyorganosiloxane-polyether. Typically, the polyether contains poly(ethylene oxide), poly(propylene oxide), or poly(ethylene oxide-co-propylene oxide), wherein the latter may be a statistical or block copolymer of the alkylene oxides. The polyorganosiloxane-polyether may be present as linear, branched or comb type polymers. The polymers may have a Si—O—C as well as Si—C linkages between the polysiloxane and the polyether segment. Examples of polyorganosiloxane-polyether are known from Moretto et al., Ullmann's Encyclopedia of Industrial Chemistry, 2000, Keyword “Silicones”, chapter 6.1, especially in Table 9. Polyorganosiloxane-polyethers are commercially available, e.g. the Dow Corning® types Q4-3667 (ABA block polymer), 5103 Surfactant (graft polymer), Q2-5211 Superwetting Agent (trisiloxane), or from Evonik Break-thru® S 240 (trisiloxane), or Break-thru® OE (graft polymer).

The viscosity of the polyorganosiloxane may vary from 10 to 50.000 cSt, preferably from 40 to 15.000 cSt.

Mixtures of polyorganosiloxanes may be used or a single type of polyorganosiloxane. Preferably, at least two different polyorganosiloxanes are used. Preferred mixtures comprise a polydimethylsiloxane and a polyorganosiloxane-polyether. Usually, the ratio of polydimethylsiloxane to polyorganosiloxane-polyether is in the range from 50 to 1 to 1 to 10, preferably from 10 to 1 to 1 to 2, and in partucular from 5 to 1 to 2 to 1.

Most preferably, the polyorganosiloxane contains (in particular consists of) a polyorganosiloxane-polyether.

The adjuvant may contain from 1 to 50 wt % polyorganosiloxanes in total. Preferably, it contains from 5 to 30 wt % polyorganosiloxanes in total, in particular from 10 to 20 wt %.

Larvicides are typically insecticides which kill larvae, for example mosquito larvae. Repellents are usually not considered larvicides. Repellents may repel insects, but do not directly harm the body of the insect. Examples are synthetic larvicides (such as temephos, dinetofuran, diflubenzuron, spinosad or methopren) and microbial larvicides (such as Bacillus thuringiensis, Bacillus thuringiensis israelensis, Bacillus sphaericus). Larvicides are commercially available, such as under the brand names Altosid® (methoprene), Abate® (temephos), GF-120 NF Naturalyte® Fruit Fly Bait (mixture of spinosad A & D), Aquabac® (Bacillus thuringiensis israelensis), or Fourstar® (Bacillus sphaericus). In one form the larvicide contains temephos, spinozad, dinetofuran, methopren, Bacillus thuringiensis, Bacillus thuringiensis israelensis, or Bacillus sphaericus.

Preferably, the larvicide is a synthetic larvicide, such as temephos, dinetofuran, diflubenzuron or methopren. In particular, the larvicide is temephos.

The adjuvant is essentially free of a larvicide. The term “essentially free” usually means that the adjuvant contains less than 0.1 wt % larvicide, preferably less than 0.05 wt %, and in particular less than 0.01 wt %. Most preferably, the adjuvant is free of a larvicide.

The weight ratio of larvicide/polyorganosiloxane in the tankmix may be from 50/1 to 1/50, preferably from 7/1 to 1/7, and in particular from 2.5/1 to 1/2.5.

The adjuvant is a liquid composition (typically at 20° C.), such as a solution, emulsion, suspension or suspoemulsion. Preferably the liquid is a solution or emulsion, in particular a solution.

The adjuvant may contain water. Usually, it contains up to 10 wt % water, preferably up to 5 wt %, and in particular up to 1 wt %. It is also possible that the adjuvant is free of water.

The adjuvant may contain an synthetic organic solvent. Synthetic organic solvents may be synthetized by human-controlled chemical synthesis. Mineral or vegetable oils are usually not considered synthetic organic solvents.

Preferred organic solvents are water-immiscible organic solvents, such as organic solvents which have a solubility in water at 20° C. of up 10 wt %, preferably up to 4 wt %, more preferably up to 2 wt %, even more preferably up to 1.5 wt %. In case the organic solvent comprises a mixture of organic solvents, typically at least 50 wt %, preferably at least 60 wt %, and in particular at least 70 wt % (based on the total amount of organic solvents) are water-immiscible organic solvents.

The organic solvent may comprise a water-immiscible organic solvents and a water-miscible organic solvent (e.g. having a solubility in water at 20 ° C. of at least 10 wt %). Preferred water-miscible organic solvent is dimethyl sulfoxide. The adjuvant may contain up to 50 wt %, preferably up to 30wt % water-miscible organic solvent.

Suitable organic solvents are ketones, esters, ether, or C₅₋₁₈ aliphatic hydrocarbons, wherein are ketones, esters, or C₅₋₁₈ aliphatic hydrocarbons are preferred. Mixtures of aforementioned solvents are also possible.

Suitable ketones are aliphatic C₅₋₁₈ ketones, preferably C₆₋₁₂ ketones, and in particular 2-heptanone.

Suitable esters are lactic acid ester (preferably lactic acid ester of aliphatic C₁₋₁₈ alcohols, more preferably lactic acid ester of aliphatic C₄₋₁₂ alcohols, in particular 2-ethylhexyl lactate), esters of aliphatic C₄₋₃₆ alcohols with aliphatic C₁₋₁₈ acids (preferably esters of aliphatic C₇₋₂₀ alcohols with aliphatic C₂₋₈ acids, and in particular isobornyl acetate), or adipic acid esters (preferably adipic acid ester of aliphatic C₁₋₁₈ alcohols, more preferably lactic acid ester of aliphatic C₂₋₈ alcohols, in particular diisopropyl adipate).

Suitable ethers are di-C₁₋₃₆ ethers, such as di-n-hexyl ether, di-n-octyl ether, di-n-decyl ether, or di-n-lauryl ether.

Preferred aliphatic hydrocarbons are C₆₋₁₈ aliphatic hydrocarbons, more preferred C₇₋₁₄ aliphatic hydrocarbons, in particular 1-methyl-4-isopropenyl-1-cyclohexen ((R)- and/or ((S)-isomers). The aliphatic hydrocarbons may be saturated or unsaturated, cyclic, branched or linear.

Preferably, the organic solvent contains at least one solvent from the group of lactic acid ester, adipic acid esters, aliphatic C₅₋₁₂ ketone, C₅₋₁₈ aliphatic hydrocarbon, and ester of aliphatic C₆₋₂₄ alcohol with aliphatic C₁₋₆ acid. More preferably, the organic solvent contains at least two solvents from the group of lactic acid ester, adipic acid esters, aliphatic C₅₋₁₂ ketone, C₅₋₁₈ aliphatic hydrocarbon, and ester of aliphatic C₆₋₂₄ alcohol with aliphatic C₁₋₆ acid. Even more preferably, the organic solvent contains at least three solvents from the group of lactic acid ester, adipic acid esters, aliphatic C₅₋₁₂ ketone, C₅₋₁₈ aliphatic hydrocarbon, and ester of aliphatic C₆₋₂₄ alcohol with aliphatic C₁₋₆ acid.

The adjuvant may contain up to 99.5 wt % of the organic solvent, preferably up to 99 wt %. Typically, the adjuvant contains at least 30 wt % of the organic solvent, preferably at least 50 wt %, more preferably at least 70 wt %, and in particular at least 80 wt %.

The adjuvant may contain 1-70 wt %, preferably 3-40 wt %, and in particular 5-20 wt % lactic acid ester. The adjuvant may contain 5-70 wt %, preferably 15-50 wt %, and in particular 20-40 wt % aliphatic C₅₋₁₂ ketone. The adjuvant may contain 5-70 wt %, preferably 15-50 wt %, and in particular 20-40 wt % C₅₋₁₈ aliphatic hydrocarbon. The adjuvant may contain 5-70 wt %, preferably 15-50 wt %, and in particular 20-40 wt % ester of aliphatic C₆₋₂₄ alcohol with aliphatic C₁₋₆ acid.

The adjuvant may contain at least 5 wt % lactic acid ester, at least 10 wt % aliphatic C₅₋₁₂ ketone, at least 10 wt % C₅₋₁₈ aliphatic hydrocarbon, and at least 10 wt % ester of aliphatic C₆₋₂₄ alcohol with aliphatic C₁₋₆ acid. Preferably, the adjuvant may contain at least 5 wt % lactic acid ester, at least 15 wt % aliphatic C₅₋₁₂ ketone, at least 15 wt % C₅₋₁₈ aliphatic hydrocarbon, and at least 15 wt % ester of aliphatic C₆₋₂₄ alcohol with aliphatic C₁₋₆ acid.

The adjuvant may comprise further common formulation additives, such as surfactants, UV-absorbers, thickeners, mineral or vegetable oil, essential oil or bactericides. Typically, the larvicides are not considered as formulation additives. Preferred additives are surfactants, especially non-ionic surfactants, such as alkoxylates. In another preferred form the adjuvant is essentially free (i.e. up to 5 wt %, preferably up to 1 wt %) of additives, especially free of non-ionic surfactants, such as alkoxylates.

The adjuvant may contain mineral or vegetable oil in addition to the synthetic organic solvent. Examples of mineral oil are oils based on petroleum distillates, such as aromatic and/or aliphatic hydrocarbon fractions. Examples of vegetable oil is oil from sunflower, canola, rapeseed, palm, soybean, peanut, cottonseed, palm cernel, coconut, or olive. The adjuvant may contain up to 15 wt % mineral or vegetable oil, preferably up to 5 wt %, more preferred up to 1 wt % and in particular up to 0.1 wt %. It is also possible that the adjuvant is free of mineral or vegetable oil.

The adjuvant may contain an essential oil. Suitable essential oils may be essential oils which are repellents to mosquitos. Examples of essential oils are citronella oil, eucalyptus oil, cinnamon oil, rosemary oil, lemongrass oil, cedar oil, peppermint oil, clove oil, and geranium oil. Preferred essential oil is eucalyptus oil.

The adjuvant may contain up to 50 wt % essential oil, preferably up to 20 wt % and in particular up to 3 wt %. The adjuvant may contain at least 0.01 wt % essential oil, preferably at least 0.1 wt % and in particular at least 1 wt %. In a further embodiment, the adjuvant is free of essential oil.

Surfactants which are particularly suitable are anionic, cationic, nonionic and amphoteric surfactants, block polymers and polyelectrolytes. Preferred surfactants are non-ionic surfactants, such as alkoxylates. Any polyorganosiloxanes are not considered as surfactant in the present invention.

Suitable anionic surfactants are alkali, alkaline earth or ammonium salts of sulfonates, sulfates, phosphates or carboxylates. Examples of sulfonates are alkylarylsulfonates, diphenylsulfonates, alpha-olefin sulfonates, sulfonates of fatty acids and oils, sulfonates of ethoxylated alkylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates and carboxylated alcohol or alkylphenol ethoxylates.

Suitable nonionic surfactants are alkoxylates, N-alkylated fatty acid amides, amine oxides, esters or sugar-based surfactants. Examples of alkoxylates are compounds such as alcohols, alkylphenols, amines (e.g. tallow amine), amides, arylphenols, fatty acids or fatty acid esters which have been alkoxylated. Ethylene oxide and/or propylene oxide may be employed for the alkoxylation, preferably ethylene oxide. Examples of N-alkylated fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides.

Preferred alkoxylates are ethoxylates of C₁₄₋₂₂ aliphatic alcohols. The alkoxylate preferably contain from 1 to 10, preferably from 1 to 4 equivalents of ethylenoxide. The HLB value according to Griffin is preferably from 3 to 15, more preferably from 3 to 10, and in particular from 3.5 to 6. Typically, the alkoxylates have a solubility in water at 20° C. of up to 5 wt %, preferably up to 2.5 wt %, and in particular of up to 1 wt %.

Examples of suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide or of the A-B-C type comprising alkanol, polyethylene oxide and polypropylene oxide. Suitable polyelectrolytes are polyacids or polybases. Examples of polyacids are alkali salts of polyacrylic acid. Examples of polybases are polyvinylamines or polyethyleneamines.

Usually, the adjuvant contains up to 30 wt % surfactant (e.g. an alkoxylate), preferably up to 20 wt %, and in particular up to 15 wt %. In another form, the adjuvant contains at least 1 wt % surfactant (e.g. an alkoxylate), preferably at least 3 wt %, and in particular at least 5 wt %. Is it also possible that the adjuvant is free of surfactants.

The adjuvant may contain inert fillers, such as inorganic inert fillers. However, it is advantageous that the adjuvant is contains only up to 3 wt % inert fillers, preferably up to 0.5 wt % and in particular up to 0.1 wt %. It is especially preferred that the adjuvant is free of inert fillers. Examples of inert fillers are calcium carbonate, talc, fine coal particulates, fly ash or cenospheres. The particle size of these inert fillers may be between 2 and 50 μm.

Typically, the adjuvant according to the invention contains from 1 to 25 wt % polyorganosiloxane, from 30 to 99 wt % organic solvent, and optionally up to 100% formulation additives.

Preferably, the adjuvant according to the invention contains from 2 to 18 wt % polyorganosiloxane, from 45 to 98 wt % organic solvent, and optionally up to 100% formulation additives.

The sum of all components, which are present in the adjuvant according to the invention sum up to 100 wt %.

Typically, the insects are aquatic insects. Aquatic insects are those that spend some part of their life-cycle closely associated with water, either living beneath the surface or skimming along on top of the water. Aquatic insects can be found in the following taxonomic orders:
Collembola, the Springtails;
Ephemeroptera, the Mayflies;
Odonata, the Dragonflies;
Plecoptera, the Stoneflies;
Hemiptera, the true Bugs;
Neuroptera/Megaloptera, the Dobsonflies, Alderflies, and Spongillaflies;
Trichoptera, the Caddisflies;
Lepidoptera, the butterflies and Moths;
Coleoptera, the Beetles;
Diptera, the true Flies.

Preferably, the insects are mosquitos, black flies, Aedes spp. (e.g. Ae. albopictus, aegypti, taeniorhynchus), Culex spp., Anopheles spp., Simuliidae ssp., or Culicoides spp.

Suitable examples of Culicidae ssp. are:

Aedes aegypti, Aedes africanus, Aedes albifasciatus, Aedes albopictus, Aedes angustivittatus, Aedes bromeliae, Aedes Canadensis, Aedes cooki, Aedes dorsalis, Aedes Aedes furcifer, Aedes hannasutai, Aedes infirmatus, Aedes japonicus, Aedes kochi, Aedes luteocephalus, Aedes mcintoshi, Aedes melanimon, Aedes niveus cpx, Aedes normanensis, Aedes oceanicus, Aedes poicilius, Aedes polynesiensis, Aedes samoanus, Aedes scapularis, Aedes scutellaris, Aedes stokesi, Aedes taeniorhynchus, Aedes taylori, Aedes togoi, Aedes triseriatus, Aedes trivittatus, Aedes tutuilae, Aedes upolensis, Aedes vexans, Aedes vigllax, Anopheles aconitus, Anopheles albimanus, Anopheles albitarsis, Anopheles annularis, Anopheles annulipes s.l., Anopheles aquasalis, Anopheles arabiensis, Anopheles argyritarsis, Anopheles atroparvus, Anopheles aztecus, Anopheles bancroftii, Anopheles barbirostris, Anopheles bellator, Anopheles benarrochi, Anopheles braziliensis, Anopheles calderoni, Anopheles campestris, Anopheles claviger, Anopheles crucians, Anopheles cruzil, Anopheles culicifacies s.l, Anopheles darlingi, Anopheles donaldi, Anopheles farauti s.l., Anopheles flavirostris, Anopheles fluviatilis, Anopheles freeborni, Anapheles funestus, Anopheles gambiae, Anopheles gambiae complex, Anopheles hancocki, Anopheles jeyporiensis, Anopheles karwari, Anopheles koliensis, Anopheles labranchiae, Anopheles lepidotus, Anopheles lesteri, Anopheles letifer, Anopheles leucosphyrus group (baimaaii, balabacensis, dirus, lateens, leucosphyrus, sulawesi), Anopheles ludlowea, Anopheles maculates s.l., Anopheles maculipennis, Anopheles marajoara, Anopheles melas, Anopheles merus, Anopheles messeae, Anopheles minimus, Anopheles moucheti, Anopheles multicolor, Anopheles neivai, Anopheles nigerrimus, Anopheles nili s.l., Anopheles nuneztovari s.l., Anopheles oswaldoi, Anopheles pattoni, Anopheles pharoensis s.l., Anopheles philippinensis, Anopheles pseudopunctipennis, Anopheles pulcherrimus, Anopheles punctimacula, Anopheles punctipennis, Anopheles punctulatus, Anopheles sacharovi, Anopheles sergentii, Anopheles sinensis, Anopheles stephensi, Anopheles subpictus s.l., Anopheles sundaicus s.l., Anopheles superpictus, Anopheles tessellatus, Anopheles triannulatus, Anopheles quadrimaculatus, Anopheles vagus, Anopheles walkeri, Anopheles wellcomei, Anopheles whartoni, Armigeres subalbatus, Coquillettidia crassipes, Coquillettidia fuscopennata, Coquillettidia perturbans, Coquillettidia venezuelensis, Culex annulirostris, Culex antennatus, Culex bitaeniorhynchus, Culex erythrothorax, Culex gelidus, Culex pipiens, Culex nigripalpus, Culex ocossa, Culex portesi, Culex quinquefasciatus, Culex restuans, Culex sitiens, Culex spissipes, Culex taeniopus, Culex tarsalis, Culex thelleri, Culex tritaeniorhynchus, Culex univittatus, Culex vishnui complex, Culex vomerifer, Culicoides furens, Culiseta inornata, Culiseta melanura, Culiseta morsitans, Haemagogus leucocelaenus, Haemagogus janthinomys, Haemagogus spegazzinii, Mansonia annulata, Mansonia bonneae, Mansonia dives, Mansonia Indiana, Mansonia titillans, Mansonia uniformis, Psorophora columbiae, Psorophora discolor, Psorophora ferox, Sabethes chloropterus, Tfichoprosopon digitatum

Suitable examples of Simulidae ssp. are:

Eusimllium spp., Prosimulium mixtum, Simulium arcticum, Similium callidum, Simllium columbaczense, Similium damnosum, Similium erythrocephalum, Similium indicum, Similium jenningsi, Similium metallicum, Similium neavei, Similium ochraceum, Similium ornatum, Similium pecuarum, Similium rugglesi, Similium venustum, Simulium vittatum

The insects may be present at any growth stage, such as eggs, egg rafts, larval instars, pupae, or adults.

The water surface may be for example the surface of a lake, river, sea, swamp, rice field, road-side ditch, swimming pool, pond, salt marsh, or water barrel.

The adjuvant may be applied with dose rate of 0.01 to 30 l/ha, preferably 0.1 to 10 l/ha, and in particular 0.3 to 5 l/ha.

A tankmix usually is a composition, which is ready to apply on the water surface. The tankmix may be liquid at 20° C. Typically, the tankmix is a sprayable liquid. The tankmix may be an aqueous liquid or water-free liquid. The tankmix may be applied with conventional means, such as spraying. It may be applied by aerial spraying or from the ground.

In another form, the method for controlling insects comprises the steps of preparing a tankmix by mixing the larvicide, the liquid adjuvant and optionally water. Preferably, first the larvicide and the adjuvant are mixed, optionally followed by mixing water with the mixture containing the larvicide and the adjuvant.

The larvicide may be present as agrochemical composition or a pure active ingredient. An agro-chemical composition comprises a pesticidally effective amount of the larvicide. The term “effective amount” denotes an amount of the larvicide, which is sufficient for controlling larvae. The agrochemical composition may contain from 0.1 to 99.9 wt % larvicide.

The larvicide can be converted into customary types of agrochemical compositions, e. g. solutions, emulsions, suspensions, dusts, powders, pastes, granules, pressings, capsules, and mixtures thereof. Examples for composition types are suspensions (e.g. SC, OD, FS), emulsifiable concentrates (e.g. EC), emulsions (e.g. EW, EO, ES, ME), capsules (e.g. CS, ZC), pastes, pastitles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). These and further compositions types are defined in the “Catalogue of pesticide formulation types and international coding system”, Technical Monograph No. 2, 6^{th} Ed. May 2008, CropLife International. Solid agrochemical compositions containing the larvicide are usually mixed with water and the adjuvant. Liquid agrochemical compositions containing the larvicide are usually mixed with the adjuvant and optionally with water.

The present invention further relates to a liquid adjuvant for preparing a larvicidal tankmix, wherein the adjuvant is essentially free of a larvicide and contains at least 1 wt % polyorganosiloxane, and at least 20 wt % synthetic organic solvent. In another embodiment, the liquid adjuvant for preparing a larvicidal tankmix consists of at least 1 wt % polyorganosiloxane, at least 20 wt % synthetic organic solvent, and optionally formulation additives. The adjuvant is especially useful for the method according to the invention. A larvicidal tankmix is usually a tankmix which contains a larvicide.

The present invention further relates to a method for preparing the adjuvant according to the present invention, comprising mixing the polyorganosiloxan and the synthetic organic solvent.

The present invention offers various advantages: The adjuvant may be easily mixed with various larvicides. The tankmix is easily sprayable. The solvents have no or very low toxicity, such as aquatoxicity. The dose rate of the larvicide may be reduced. The dose rate of the polysiloxane may be reduced. The application is very easy and it is very efficient. The larvicide spreads easily and fast over a water surface. There is a dual mode of action on developing larvae, namely the direct kill and the inhibition of the pupal eclosion. The efficiency is prolonged compared to either the larvicide or the polyorganosiloxane alone. The adjuvant is storage stable.

The invention is further illustrated but not limited by the following examples.

### EXAMPLES

Silicone A: alkoxylated Polydimethylsiloxan (also known as Polydimethylsiloxan-polyether), soluble in water (room temperature, 10 wt %), dynamic Viscosity 2000-3500 mPas (25° C.).

Alkoxylate A: nonionic ethoxylated alcohol, molecular mass below 600 g/mol, liquid at 20° C., solubility in water at 20° C. below 0.5 wt %.

### Examples 1-2

### Preparation of Adjuvants

The liquid adjuvants were prepared by mixing the components as listed in Table 1.

TABLE 1
Amounts of components [g]

| Component | Example 1 | Example 2 |
|---|---|---|
| Silicone A | 6 | 6 |
| Alkoxylate A | 10 | — |
| D-(+)-1-Methyl-4-isopropenyl-1-cyclohexen | 25 | 27 |
| 2-Heptanone | 25 | 27 |
| Isobornyl acetate | 25 | 27 |
| 2-Ethylhexyl lactate | 10 | 12 |

1-15. (canceled)

16. A method for controlling insects comprising the steps of preparing a tankmix by mixing a larvicide and a liquid adjuvant, wherein the adjuvant is essentially free of the larvicide and contains
at least 1 wt % polyorganosiloxane,
at least 20 wt % synthetic organic solvent; and
applying the tankmix on a water surface,
wherein the organic solvent contains at least three solvents from the group of lactic acid ester, adipic acid esters, aliphatic C₅₋₁₂ ketone, C₅₋₁₈ aliphatic hydrocarbon, and ester of aliphatic C₆₋₂₄ alcohol with aliphatic C₁₋₆ acid.

17. The method according to claim 16, wherein the insects are aquatic insects.

18. The method according to claim 16, wherein the water surface is that of a lake, river, sea, swamp, rice field, roadside ditch, swimming pool, salt marsh, or water barrel.

19. The method according to claim 16, wherein the polyorganosiloxane comprises polyorganosiloxane-polyether.

20. The method according to claim 16, wherein the adjuvant contains at least 5 wt % lactic acid ester, at least 10 wt % aliphatic C₅₋₁₂ ketone, at least 10 wt % C₅₋₁₈ aliphatic hydrocarbon, and at least 10 wt % ester of aliphatic C₆₋₂₄ alcohol with aliphatic C₁₋₆ acid.

21. The method according to claim 16, wherein the adjuvant contains
from 1 to 25 wt % polyorganosiloxane, and
from 30 to 99 wt % organic solvent.

22. The method according to claim 16, wherein the larvicide contains temephos, spinosad, dinetofuran, methopren, Bacillus thuringiensis, Bacillus thuringiensis israelensis, or Bacillus sphaericus.

23. The method according to claim 16, wherein the adjuvant contains up to 10 wt %, preferably up to 5 wt %, and in particular up to 1 wt % water.

24. The method according to claim 16, wherein the adjuvant contains up to 5 wt %.

25. The method according to claim 16, wherein the adjuvant contains up to 1 wt % water.

26. A liquid adjuvant for preparing a larvicidal tankmix, wherein the adjuvant is essentially free of a larvicide and contains
at least 1 wt % polyorganosiloxane, and
at least 20 wt % synthetic organic solvent,
wherein the organic solvent contains at least three solvents from the group of lactic acid ester, adipic acid esters, aliphatic C₅₋₁₂ ketone, C₅₋₁₈ aliphatic hydrocarbon, and ester of aliphatic C₆₋₂₄ alcohol with aliphatic C₁₋₆ acid.

27. The adjuvant according to claim 26, wherein the larvicide contains temephos, dinetofuran, diflubenzuron, spinosad, methopren, Bacillus thuringiensis, Bacillus thuringiensis israelensis, or Bacillus sphaericus.

28. The adjuvant according to claim 26, containing at least 5 wt % lactic acid ester, at least 10 wt % aliphatic C₅₋₁₂ ketone, at least 10 wt % C₅₋₁₈ aliphatichydrocarbon, and at least 10 wt % ester of aliphatic C₆₋₂₄ alcohol with aliphatic C₁₋₆ acid.

29. The adjuvant according to claim 26, comprising
from 1 to 25 wt % polyorganosiloxane, and
from 30 to 99 wt % organic solvent.

30. The adjuvant according to claim 26 wherein the polysiloxane comprises a polyorganosiloxane-polyether.

31. The adjuvant according to claim 26 containing up to 10 wt %, preferably up to 5 wt %, and in particular up to 1 wt % water.

32. A method for preparing the adjuvant as defined in claim 16, comprising mixing the polyorganosiloxan and the synthetic organic solvent.
